(19) United States
(12) Patent Application Publication
(10) Pub. No.: US 2017/0203155 A1
(43) Pub. Date: Jul. 20, 2017

(54) ATHLETIC PERFORMANCE MEASURING APPARATUS

(71) Applicant: Seiko Epson Corporation, Shinjuku-ku (JP)

(72) Inventor: Minehisa IMAMURA, Shiojiri-shi (JP)

(21) Appl. No.: 15/410,153

(22) Filed: Jan. 19, 2017

(30) Foreign Application Priority Data
Jan. 20, 2016 (JP) 2016-008514

(51) Int. Cl. A63B 24/00; G09B 19/00; A63B 71/06

(52) U.S. Cl. CPC A63B 24/0062; A63B 71/0619; G09B 19/0038; A63B 2024/0065; A63B 2230/04; A63B 2225/50; A63B 2220/40; A63B 2220/62; A63B 2220/22; A63B 2220/30; A63B 2220/73; A63B 2230/75

(57) ABSTRACT

A running measuring apparatus includes a positional information detection sensor and a bio-information detection sensor, an operation button which receives an input, and a processing portion, the processing portion calculates athletic performance information based on an output from the sensor, performs first processing related to the athletic performance information in a case where the operation button receives a first input, performs the first processing in a case where the operation button receives a second input of which the number of operations is smaller than that of the first input, and invalidates a response to the second input in a case where the operation button receives a first setting.

### CROSS-REFERENCE TO RELATED APPLICATIONS

The entire disclosure of Japanese Patent Application No. 2016-008514, filed Jan. 20, 2016 is expressly incorporated by reference herein.

### BACKGROUND

1. Technical Field

The present invention relates to an athletic performance measuring apparatus.

2. Related Art

An apparatus for monitoring athletic performance which collects information that is useful for training by providing a receiver that detects a position after receiving a satellite signal sent from a global positioning system (GPS) satellite or a sensor that measures a heartbeat, and by being carried by a user who performs training (for example, refer to JP-A-2015-132612), is known.

In general, such an apparatus can display a menu screen, and the user instructs a setting related to measurement or information collection in accordance with the menu screen. However, since the menu generally has a layered structure of a plurality of screens, the operation was complicated.

Meanwhile, there is an apparatus which more simply finishes an operation for performing a desirable setting, and has a shortcut function.

The shortcut function can perform a desirable setting with respect to the athletic performance monitoring apparatus by a simple operation, but it is necessary for the user to understand an operation of the shortcut and a function which corresponds to the operation. Therefore, the apparatus is useful to the user who learned the operation of the athletic performance monitoring apparatus, but there is a case where the apparatus is difficult to use for the user who is not accustomed to the operation, and the athletic performance cannot be correctly measured due to malfunction.

### SUMMARY

An advantage of some aspects of the invention is to provide an athletic performance monitoring apparatus which has excellent handlability with respect to an input operation.

The invention can be implemented as the following forms or application examples.

### Application Example 1

An athletic performance measuring apparatus according to this application example includes: at least one sensor; at least one input portion which receives an input; and a processor, in which the processor calculates athletic performance information based on an output from the sensor, performs first processing related to the athletic performance information in a case where at least the one input portion receives a first input, performs the first processing in a case where at least the one input portion receives a second input of which the number of operations is smaller than that of the first input, and invalidates a response to the second input in a case where at least the one input portion receives a first setting.

According to this configuration, the first processing related to the athletic performance information which is performed in a case where the input portion receives the first input, is also performed in a case where the input portion receives the second input of which the number of operations is smaller than that of the first input. Furthermore, the response to the second input can be invalidated in a case where the input portion receives the first setting. Therefore, since the second input of which the number of operations is smaller than that of the first input can be invalidated by the first setting, regarding the input of the athletic performance measuring apparatus, it is possible to make the handlability excellent compared to a case where the second input cannot be invalidated.

### Application Example 2

In the athletic performance measuring apparatus according to the application example, it is preferable that the processor validates the response in a case where at least the one input portion receives a second setting.

According to this configuration, since the response to the second input can be validated in a case where the input portion receives the second setting, it is possible to set the response to the second input to be valid by the input to the input portion.

### Application Example 3

In the athletic performance measuring apparatus according to the application example, it is preferable that a storage portion which stores a parameter that corresponds to the first setting or the second setting is further provided, the processor stores the parameter in the storage portion in accordance with the first setting or the second setting which is received by at least the one input portion, and in a case where at least the one input portion receives the second input, it is determined whether the response is valid or invalid based on the parameter stored in the storage portion.

According to this configuration, the athletic performance measuring apparatus stores the parameter which corresponds to the first setting or the second setting in the storage portion in accordance with the first setting or the second setting. In a case where the second input is received, since it is determined that the response to the second input is valid or invalid based on the stored parameter, for example, the handlability is excellent in a case where the user repeatedly uses the first setting or the second setting.

### Application Example 4

In the athletic performance measuring apparatus according to the application example, it is preferable that the processor performs a control which corresponds to an instruction related to a supply of a power source in a case where at least the one input portion receives the first setting and in a case where the second input is the instruction related to the supply of the power source.

According to this configuration, in a case where the second input is the instruction related to the supply of the power source, even if the first setting is received, the control related to the supply of the power source is performed, and thus, even in a case where the response to the second input is invalid, the user rapidly performs the instruction related to the supply of the power source.

### Application Example 5

In the athletic performance measuring apparatus according to the application example, it is preferable that the first processing includes at least one of operating a predetermined function related to the athletic performance and finishing the predetermined function related to the athletic performance.

According to this configuration, regarding at least one of the operating the predetermined function and the finishing the predetermined function, it is possible to set the response to the second input to be invalid by the input to the input portion.

### Application Example 6

In the athletic performance measuring apparatus according to the application example, it is preferable that a display portion which displays a first screen and a second screen that configure a layered structure is further provided, and the operating the predetermined function includes transiting display of the display portion from the first screen to the second screen.

According to this configuration, the operating the predetermined function includes switching the display of the display portion from the first screen to the second screen. Since the first screen and the second screen configure the layered structure, there is a possibility that the operation of the user can be simply performed when the switching can be performed in a case where the second input is received by the input portion. Meanwhile, since invalidation is also possible by the first setting, compared to a case where the invalidation is not possible, the handlability is excellent.

### Application Example 7

In the athletic performance measuring apparatus according to the application example, it is preferable that a display portion which displays a first screen and a second screen that configure a layered structure is further provided, and the finishing the predetermined function includes transiting display of the display portion from the second screen to the first screen.

According to this configuration, by finishing the predetermined function, a first layered screen is displayed in the display portion by switching a displayed second layered screen.

### Application Example 8

In the athletic performance measuring apparatus according to the application example, it is preferable that the sensor includes at least one of a positional information detection sensor which detects positional information and a bio-information detection sensor which detects bio-information.

According to this configuration, based on at least one of the positional information and the bio-information, the athletic performance information is obtained.

### BRIEF DESCRIPTION OF THE DRAWINGS

The invention will be described with reference to the accompanying drawings, wherein like numbers reference like elements.

FIG. 1 is an external view including a display region of a running measuring apparatus according to an embodiment.

FIG. 2 is a block diagram illustrating a functional configuration of the running measuring apparatus.

FIG. 3 is a view illustrating an example of transition of a menu screen and a shortcut operation.

FIG. 4 is a view illustrating an order of validating a shortcut.

### DESCRIPTION OF EXEMPLARY EMBODIMENTS

Hereinafter, an embodiment of the invention will be described with reference to the drawings.

### Embodiment

Hereinafter, an athletic performance measuring apparatus according to the embodiment will be described with reference to the drawings.

### (1) Configuration of Running Measuring Apparatus

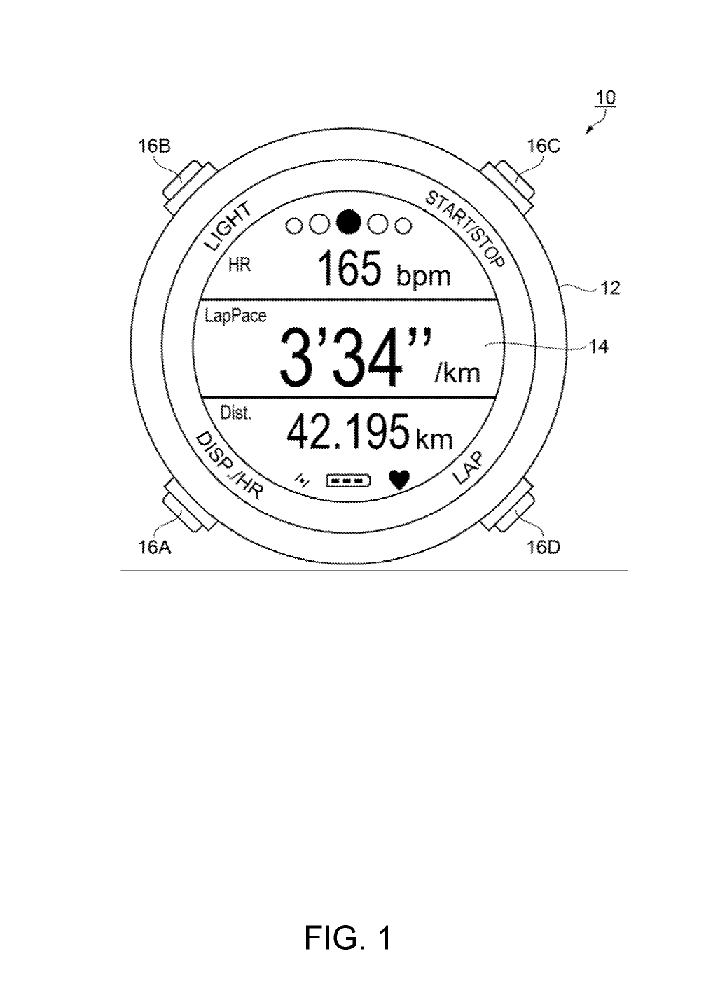

FIG. 1 is an external view of a display region of a running measuring apparatus 10 which is one example of the athletic performance measuring apparatus. The running measuring apparatus 10 is used by employing an aspect of a wrist watch and by wearing the wrist watch in an arm portion of a user. Furthermore, the running measuring apparatus 10 may be called a “running watch”, a “training watch”, and a “runners' watch”.

In a case where the user wears the running measuring apparatus 10 in the arm portion via a belt which is not illustrated, a rear surface of a housing portion 12 can tightly adhere to the arm portion, and a front surface of the housing portion 12 having a display region can be visually confirmed by the user. A display panel 14 is disposed on the front surface of the housing portion 12, and operation buttons (16A, 16B, 16C, and 16D) which can be pressed are disposed in a side surface portion of the housing portion 12. Therefore, in a state where the user wears the running measuring apparatus 10, while visually confirming information displayed in the display panel 14, it is possible to operate the operation buttons (16A, 16B, 16C, and 16D) by a finger.

Since the running measuring apparatus 10 has a function of measuring pulses in addition to a running measuring function, such as a split time function or a lap time function during the running or jogging, and a target function including running time or running distance, it is possible to easily perform heartbeat training. An example of FIG. 1 is an example of the display when the measurement of running is performed. At an upper part of the screen, in a region written as “HR”, five circular figures (the filled circle indicates a current heartbeat zone) illustrating five-stepped heartbeat zone, and a heart rate (165 bpm, bpm is beats per minute), are displayed.

In addition, at an intermediate part of the screen, in a region described as “LapPace”, an average pace (in this case, 3 minutes 34 seconds per 1 km) for each section set when running, is displayed.

In addition, at a lower part of the screen, in a region described as “Dist”, a total moving distance (in this case, 42.195 km) from the start of the measurement is displayed.

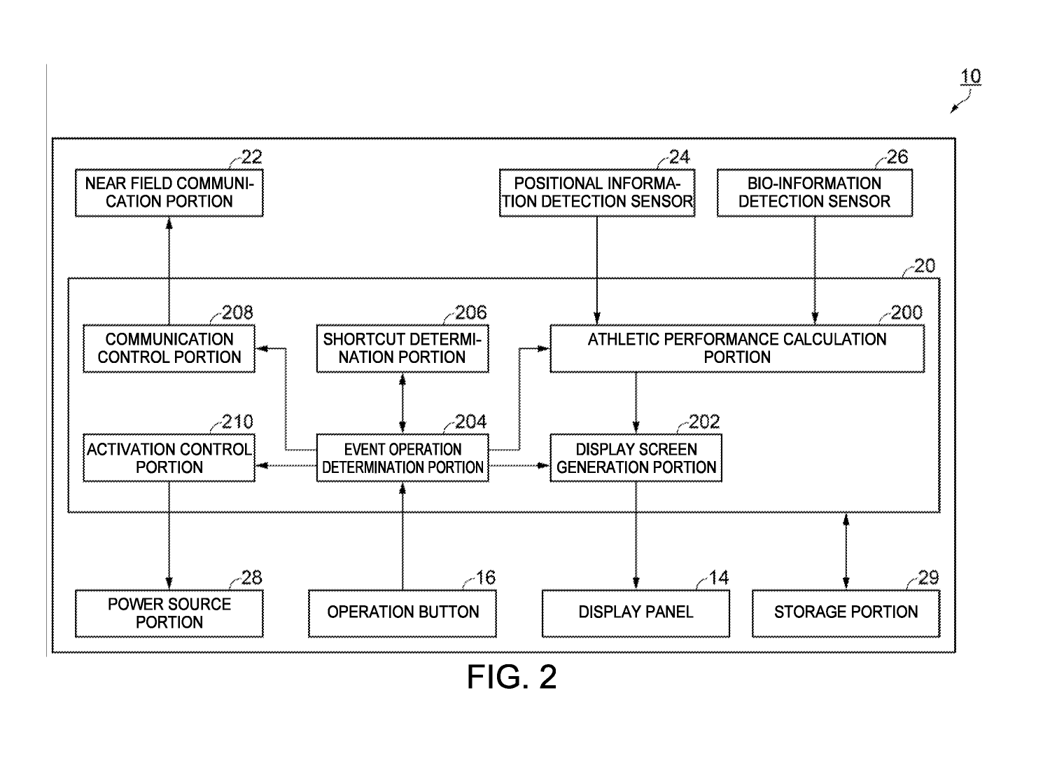

FIG. 2 is a block diagram illustrating a functional configuration of the running measuring apparatus 10. The running measuring apparatus 10 includes the display panel 14, the operation button 16, a processing portion 20, a near field communication portion 22, a positional information detection sensor 24, a bio-information detection sensor 26, a power source portion 28, and a storage portion 29.

In addition, the processing portion 20 includes an athletic performance calculation portion 200, a display screen generation portion 202, an event operation determination portion 204, a shortcut determination portion 206, a communication control portion 208, and an activation control portion 210.

The display panel 14 corresponds to a display portion, for example, a liquid crystal panel.

The operation button 16 corresponds to an input portion which receives an operation instruction from the user, and in the embodiment, the operation button 16 is the operation buttons (16A, 16B, 16C, and 16D) disposed in the side surface portion of the housing portion 12. Furthermore, the input portion is not limited only to the operation button 16, and for example, the operation button 16 and a touch panel may function as an input portion by using the touch panel as the display panel 14. In addition, the operation instruction can be made by input by voice or a mode in which the operation instruction is input via communication from an information terminal (not illustrated) such as a smartphone. In the embodiment, there are four operation buttons 16, but at least one input portion which is necessary for realizing the function of the device may be employed.

The processing portion 20 corresponds to a processor, and for example, is configured of a micro processing unit (MPU), a digital signal processor (DSP), and an application specific integrated circuit (ASIC). The processing portion 20 follows a program stored in the storage portion 29, and an operation instruction input by the user via the operation button 16, and realizes the function by allowing various processing to collaborate with hardware. Description of each functional portion of the processing portion 20 will be described later.

The near field communication portion 22 performs various controls for establishing data communication between the near field communication portion 22 and the information terminal. The near field communication portion 22 includes a sending and receiving machine which corresponds to a near field communication standard, such as Bluetooth (registered trademark) (including Bluetooth Low Energy (BTLE)), Wireless Fidelity (Wi-Fi (registered trademark)), Zigbee (registered trademark), near field communication (NFC), and ANT+(registered trademark).

The positional information detection sensor 24 detects the positional information related to a position of the running measuring apparatus 10. In the embodiment, for example, the positional information detection sensor 24 receives a satellite signal sent from a GPS satellite or a positioning satellite, such as a quasi-zenith satellite, obtains the current positional information based on the received satellite signal by a known position calculation operation, and outputs a positional signal including the positional information.

In addition, the positional information detection sensor 24 may also calculate the positional information based on an electric wave, such as Wi-Fi (registered trademark) or iBeacon (registered trademark), in a room.

The bio-information detection sensor 26 is considered as a pulse wave sensor which detects a pulse wave. The pulse wave sensor is provided with a light generating element, such as an LED, and a light receiving element, such as a photodiode. The pulse wave sensor is disposed on the rear surface side of the housing portion 12, and opposes the arm portion in a case where the user wears the running measuring apparatus 10.

The pulse wave sensor emits outgoing light toward a living body from the light generating element, receives reflected light which reaches via a blood vessel of the arm portion by the light receiving element, and outputs a pulse wave signal which corresponds to the pulse wave from variation information of a light receiving amount by using a phenomenon in which reflectivity of the light varies when expanding and contracting the blood vessel by characteristics of absorbing the light of hemoglobin in blood.

In addition, in the embodiment, as the bio-information detection sensor 26, an acceleration sensor or a gyro sensor which outputs a body movement signal that corresponds to the movement of a body of the user, is further provided.

The power source portion 28 is considered as a secondary battery which can be repeatedly used similar to a rechargeable battery, and supplies power for maintaining the operation of the running measuring apparatus 10.

The storage portion 29 is configured of an IC memory, and includes a read only memory (ROM) in which a program or the like is stored, and a random access memory (RAM) which becomes a work region of the processing portion 20. In addition, setting information for calculating athletic performance of the user or information of the calculated athletic performance, is also stored in the storage portion 29.

### (2) Function of Processing Portion

Next, each functional portion of the processing portion 20 will be described.

The athletic performance calculation portion 200 calculates the athletic performance (athletic performance information) of the user based on the positional signal output by the positional information detection sensor 24, and the pulse wave signal and the body movement signal which are output by the bio-information detection sensor 26.

In the athletic performance, at least one of the split time, the lap time, the travelling distance, the travelling pace, the speed, the stride, the expected reaching time, the altitude, the consumed calories, the pitch, and the heartbeat rate, is included.

The athletic performance calculation portion 200 calculates at least one of the above-described athletic performance. In a case where the positional signal output by the positional information detection sensor 24 is the information to be used in position calculation (for example, satellite orbit information or a signal down-converted to an intermediate frequency), the athletic performance calculation portion 200 calculates the current positional information based on the positional signal. Furthermore, since a method of calculating the positional information based on the satellite signal sent from the positioning satellite, is a known method, the description thereof will be omitted.

In addition, the athletic performance calculation portion 200 calculates the bio-information or the body moving information based on the pulse wave signal and the body movement signal which are output by the bio-information detection sensor 26. Furthermore, as a method of calculating the bio-information or the body moving information from the pulse wave signal and the body movement signal, a method disclosed in JP-A-2013-208311 can be employed.

In addition, the athletic performance calculation portion 200 generates time information, such as year, month, day, hour, minute, or second, from a real time clock (RTC) IC provided in the running measuring apparatus 10.

In a case where the athletic performance calculation portion 200 receives the operation instruction sent from the event operation determination portion 204, the athletic performance calculation portion 200 calculates the positional information, the bio-information, or the body moving information in accordance with the instructed athletic performance, obtains the setting information or the time information, and calculates the instructed athletic performance. In addition, the athletic performance calculation portion 200 outputs the calculated athletic performance result to the display screen generation portion 202, or stores the result in the storage portion 29.

Based on the operation instruction sent from the event operation determination portion 204, the display screen generation portion 202 generates a screen displayed in the display panel 14, and displays the generated screen in the display panel 14.

In addition, in a case where the display screen generation portion 202 receives the operation instruction related to the athletic performance from the event operation determination portion 204, based on the athletic performance result output from the athletic performance calculation portion 200, the display screen generation portion 202 generates a result screen of the athletic performance, and displays the generated result screen in the display panel 14.

The event operation determination portion 204 receives the operation of the operation button 16, generates the operation instruction in accordance with the pressed operation button 16, and sends the generated operation instruction to the athletic performance calculation portion 200, the display screen generation portion 202, the communication control portion 208, and the activation control portion 210.

In addition, in a case where the event operation determination portion 204 receives the shortcut operation by the operation button 16, the event operation determination portion 204 inquires of the shortcut determination portion 206 whether the shortcut operation is valid or invalid, and in a case where it is determined that the shortcut operation is valid, the event operation determination portion 204 sends an operation instruction which corresponds to the shortcut determined in advance to the athletic performance calculation portion 200, the display screen generation portion 202, the communication control portion 208, and the activation control portion 210.

Furthermore, in the embodiment, in a case where the shortcut operation is invalid, the event operation determination portion 204 invalidates a response to the shortcut operation. In other words, the operation instruction which corresponds to the shortcut is not output, or the shortcut operation is not received.

The shortcut determination portion 206 stores information in the storage portion 29 as shortcut information which is a parameter for determining whether the shortcut operation is valid or invalid, and determines the response by reading out the shortcut information from the storage portion 29 in accordance with an inquiry from the event operation determination portion 204.

The shortcut operation by the shortcut determination portion 206 and the event operation determination portion 204 will be described later.

In a case where the communication control portion 208 receives a communication instruction from the event operation determination portion 204, the communication control portion 208 communicates with an information terminal by controlling the near field communication portion 22. In the embodiment, the communication control portion 208 sends the athletic performance result stored in the storage portion 29 to the information terminal, and the information terminal is considered as an aspect of performing statistical processing or the like by an application based on the received athletic performance result.

In a case where the activation control portion 210 receives an activation instruction or a finishing instruction from the event operation determination portion 204, the activation control portion 210 controls the power source portion 28 in accordance with the received instruction, and performs activation or shutting-down of the running measuring apparatus 10.

Furthermore, in the embodiment, the activation or the shutting-down of the running measuring apparatus 10 is performed by the shortcut operation by pressing the operation button 16A for a long time, but even in a case where the shortcut operation is set to be invalid by the shortcut information, the shortcut operation related to the supply of the power source such as the activation or the shutting-down, becomes valid. Accordingly, the activation or the shutting-down of the running measuring apparatus 10 is rapidly and easily performed. In addition, in a case where the supply of the power source is controlled only by the shortcut operation, it is possible to prevent the activation or the shutting-down of the running measuring apparatus 10 from not being performed due to invalidating of the shortcut operation.

### (3) Transition of Menu Screen

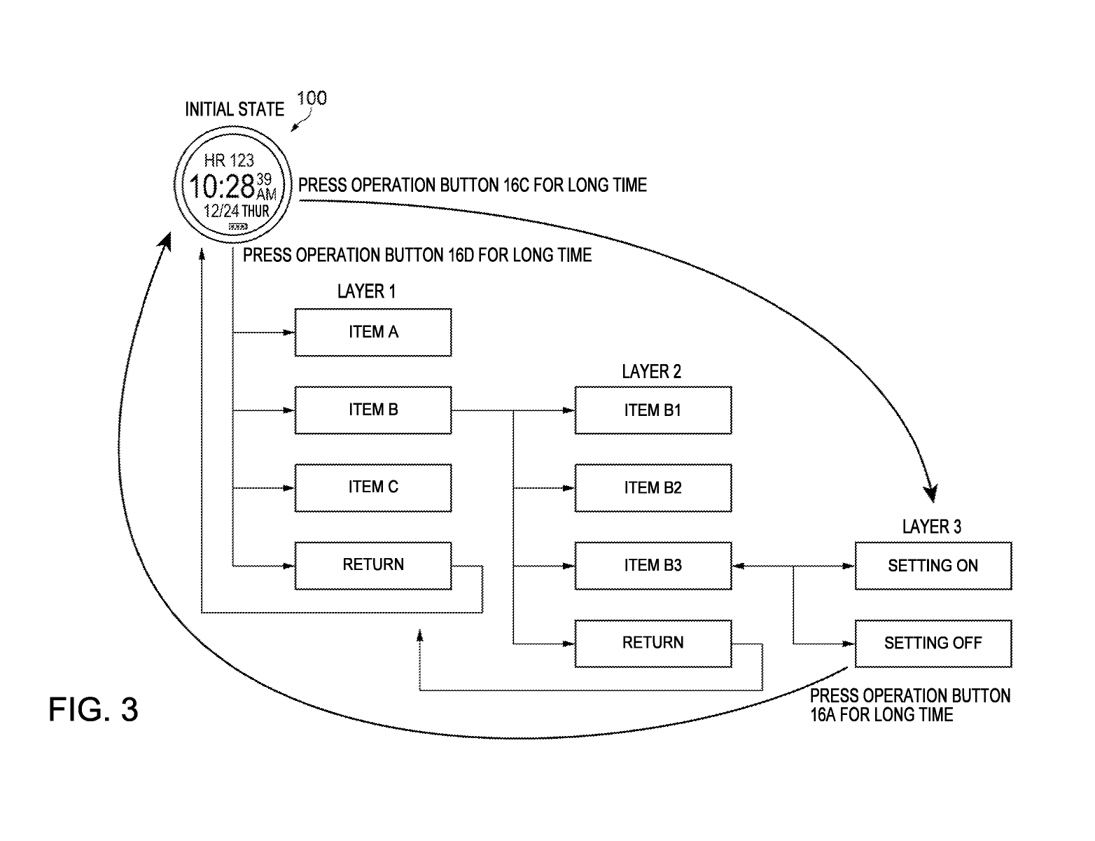

FIG. 3 is a view illustrating an example of transition of the menu screen and the shortcut operation. In this case, a time piece screen 100 is displayed in the display panel 14 as an initial state.

First, the screen transition in a case where the shortcut operation is invalid will be described.

In a case where the time piece screen 100 is displayed, for example, when the user presses the operation button 16D, the processing portion 20 displays a menu screen (not illustrated) in the display panel 14 by switching from the time piece screen 100. The menu screen is a menu screen of the highest layer (layer 1) among the layer screens (menu) having a layered structure, and as choices, “item A”, “item B”, “item C”, and “Return” are displayed to be selectable. In addition, in the example, the time piece screen 100 is not included in the layer screen, but the time piece screen may be the highest layer of the layer screen.

Here, in a case where the user selects the “item B” by the button operation, the processing portion 20 displays the menu screen of the next layer (layer 2). As the choices of the menu screen, “item B1”, “item B2”, “item B3”, and “Return” are displayed to be selectable.

Furthermore, in the embodiment, when pressing the operation button 16C, an upper choice in the menu screen becomes a candidate for the selection. In addition, when pressing the operation button 16C, a lower choice in the menu screen becomes a candidate for the selection. In addition, when pressing the operation button 16A, the choice for the selection is determined.

Here, in a case where the user selects the “item B3” by the button operation, the processing portion 20 displays the menu screen of the lower layer (layer 3). In this manner, the menu screen of the layer 3 can be reached by a plurality of operations from the menu screen of the layer 1.

The menu screen is a set screen with respect to the “item B3” of the layer 2, and the choice is “setting ON” or “setting OFF”. When the user selects any of the choices, the processing portion 20 determines the setting, and returns to the menu screen of the layer 2.

Furthermore, the operation (the operation or the operation input of the operation button 16) of selecting the “item B”, the “item B3”, and the “setting ON” or the “setting OFF” by the user corresponds to the first input, and the setting of the processing portion 20 which corresponds to the “setting ON” or the “setting OFF” corresponds to the first processing.

Furthermore, as the user selects the “Return” on the menu screen of the layer 2, returns to the menu screen of the layer 1, and selects the “Return” on the menu screen of the layer 1, the processing portion 20 displays an initial state, that is, the time piece screen 100 in the display panel 14.

Next, the screen transition in a case where the shortcut operation is valid will be described.

In a case where the first screen, that is, the time piece screen 100, is displayed, when the user performs the input operation in which the number of operations is smaller than that of the first input, for example, presses the operation button 16C for a long time, the processing portion 20 inquires of the shortcut determination portion 206, and obtains determination result that the shortcut operation is valid. Accordingly, the processing portion 20 skips the layer 1 and the layer 2, and displays the second screen, that is, the menu screen of the layer 3 in the display panel 14. In addition, the second screen is not limited to the screen of the layer 3 as will be described later.

Here, as the user selects any choice from the menu screen of the layer 3, and further presses the operation button 16A for a long time, the processing portion 20 determines the selected setting, and transits to the first layer screen which displays the time piece screen 100 in the display panel 14.

Furthermore, the pressing the operation button 16C and the operation button 16A for a long time (an example of the shortcut operation) corresponds to the second input.

In this manner, by pressing the predetermined operation button 16 for a long time, as an example of restoring the screen in an initial state from the transited screen, the following aspects can also be considered.

1. In a case where the athletic performance calculation portion 200 temporarily stops the calculation of the athletic performance, or in a case where the athletic performance calculation portion 200 performs the calculation of the athletic performance, by pressing the predetermined operation button 16 for a long time, data of the athletic performance which has been calculated is stored in the storage portion 29, and returns to the time piece screen 100 or the like. In this case, a screen displayed when the calculation of the athletic performance is temporarily stopped, or a screen displayed in the middle of the calculation, may correspond to the second screen. In order to return to the time piece screen 100 in a form of menu screen, a screen on which the selection of whether or not the screen returns to the time piece screen 100 is performed, or a screen of confirming whether to return or not, is displayed, and the user performs the selection or the confirmation by the button operation.

2. In a case where the athletic performance calculation portion 200 displays the calculated athletic performance in the display panel 14, or in a case where the athletic performance calculation portion 200 displays history in the display panel 14, that is, when the user sees and confirms the display panel 14 related to the information, the screen returns to the time piece screen 100 or the like by pressing the predetermined operation button 16 for a long time.

In addition, as an example other than the restoration to the screen in the initial state, an aspect in which the communication control portion 208 starts the wireless communication with respect to the near field communication portion 22 by pressing the predetermined operation button 16 for a long time on the time piece screen 100 or the like, can also be considered.

In addition, as another example, an aspect of allowing the athletic performance calculation portion 200 to start the calculation or the recording of the athletic performance by pressing the predetermined operation button 16 for a long time on the time piece screen 100 or the like, or allowing the positional information detection sensor 24 or the bio-information detection sensor 26 to start the detection, can also be considered.

In this manner, the screen can be rapidly transited from the initial state to the set screen by employing the shortcut, and additionally, the screen also can be rapidly transited from the set screen to the initial state. In particular, a case of being transited to the initial state, saves the user a trouble of selecting the “Return” in each layer.

### (4) Setting of Shortcut Operation

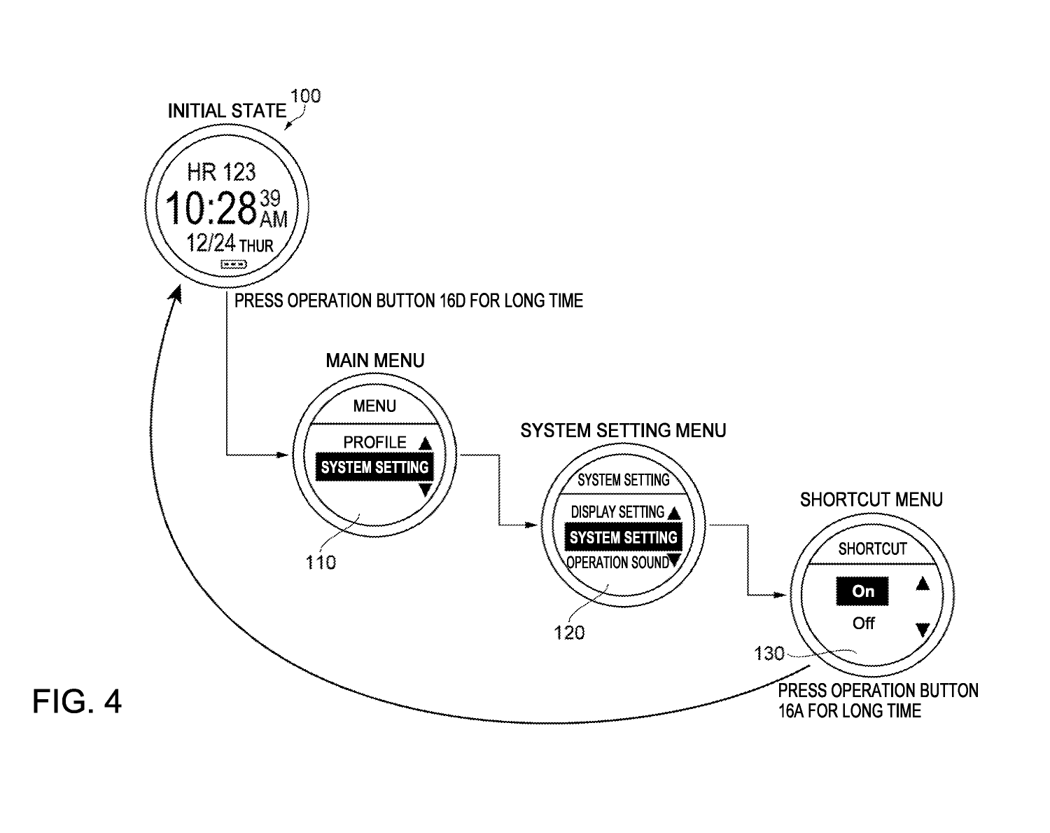

In the embodiment, by performing a first setting by operating the operation button 16, the user can set the shortcut information illustrating that the shortcut is invalid. In addition, by performing a second setting by operating the operation button 16, the user can set the shortcut information illustrating that the shortcut is valid. FIG. 4 is a view illustrating an order of validating the shortcut.

In a case where the time piece screen 100 is displayed, for example, when the user presses the operation button 16D, the processing portion 20 displays a main menu screen 110 in the display panel 14 instead of the time piece screen 100. The main menu screen 110 is a menu of the highest layer, and as the choices, “Profile” and “System Setting” are displayed to be selectable.

Here, the user selects the “system setting”, and the processing portion 20 displays a system setting menu screen 120 in the display panel 14. As the choices of the system setting menu screen 120, “Display Setting”, “Shortcut”, and “Operation Sound”, are displayed to be selectable.

Here, the user selects the “Shortcut”, and the processing portion 20 displays a shortcut menu screen 130. The choice of the shortcut menu screen 130 is “ON” or “OFF” with respect to the shortcut. When the user selects the “ON”, the processing portion 20 sets the shortcut operation to be valid. In addition, when the user selects the “OFF”, the processing portion 20 sets the shortcut operation to be invalid.

Here, as the user selects the “ON”, that is, validation of the shortcut operation, the following shortcut becomes valid. Therefore, in the shortcut menu screen 130, in a case of a shortcut operation of returning to the initial state, and in this case, in a case where the operation button 16A is pressed for a long time, the processing portion 20 skips the system setting menu screen 120 and the main menu screen 110, and transits the state to the initial state where the time piece screen 100 is displayed in the display panel 14.

Furthermore, at the time of factory shipment of the running measuring apparatus 10, the shortcut operation may be valid or may be invalid. In a case where the shortcut operation is valid, the user can use the shortcut operation from the time when the running measuring apparatus 10 is initially activated, and thus, this saves the user a trouble of the operation. In addition, in a case where the shortcut operation is invalid, it is possible to avoid an error caused by the user who is not accustomed to the shortcut.

In addition, in the embodiment, a state where one of the operation buttons (16A, 16B, 16C, and 16D) is pressed for a long time, that is, a state where one of the operation buttons (16A, 16B, 16C, and 16D) is continuously pressed beyond the predetermined time, is a trigger of the shortcut operation, but the invention is not limited thereto. For example, a case where two or more of the operation buttons (16A, 16B, 16C, and 16D) are pressed for a long time at the same time may be a trigger. In addition, in a state where one of the operation buttons (16A, 16B, 16C, and 16D) is pressed for a long time, a case where another one of the operation buttons (16A, 16B, 16C, and 16D) is pressed, can also be considered.

In addition, in a case where a touch panel is further provided as an input portion, a predetermined region may be pressed for a long time, or a pinch operation of the predetermined region may be employed as a trigger. In addition, in a case of being corresponded to a voice input, a predetermined keyword may be confirmed. In addition, the input may be performed from at least two of the operation buttons (16A, 16B, 16C, and 16D), the touch panel, and the voice input, at the same time. In addition, an aspect in which a general input operation is performed by any of the touch panel and the voice input, and the shortcut operation is allotted to be performed by the operation buttons (16A, 16B, 16C, and 16D), can also be considered.

According to the above-described embodiment, the following effects can be achieved.

(1) The running measuring apparatus 10 stores the shortcut information illustrating whether the shortcut operation is valid or invalid in the storage portion 29, and performs the shortcut based on the stored shortcut information. Therefore, the user who is accustomed to the operation of the running measuring apparatus 10 can rapidly perform a desirable function by validating the shortcut operation. Meanwhile, invalidation of the shortcut operation can save the user who is not accustomed to the operation of the running measuring apparatus 10 a trouble of learning the shortcut operation, and at the same time, a malfunction can be avoided.

(2) In a case where the shortcut operation is valid, the running measuring apparatus 10 can also perform, in addition to the shortcut in one direction in which the screen is transited to a predetermined screen from the main menu screen 110, the shortcut in the direction reverse to the one direction in which the screen is transited to the main menu screen 110 from a predetermined screen and thus, the shortcut is possible in both directions. Therefore, the user can rapidly restore the screen to the main menu screen 110 after performing a desirable function.

Above, the invention is described based on the embodiment illustrated in the drawings, but the invention is not limited to the embodiment, and modification examples similar to the example which will be described hereinafter can also be considered.

(1) The information illustrating that the shortcut operation is valid or invalid may be displayed in the display panel 14. For example, in a case where the display panel 14 can be displayed in color, a part of the region may be displayed in a color change manner. In addition, the running measuring apparatus 10 may be provided with a light source, such as a light emitting diode (LED), and may illustrate a valid/invalid state of the shortcut operation by lighting the LED.

(2) The shortcut information set on the running measuring apparatus 10 may be set via the communication from the information terminal. In addition, the shortcut information may be stored in the storage portion 29 for each user, and may be changed in accordance with the user who uses the running measuring apparatus 10. Accordingly, it is possible to set the valid/invalid state of the shortcut for each user.

(3) The shortcut function by the shortcut operation of the running measuring apparatus 10 is determined in advance as a specification, but the user may set the shortcut function by the setting from the information terminal or the like.

(4) The shortcut information may set the operation of transiting the screen from the main menu screen 110 to the predetermined screen and the operation of transiting the screen from the predetermined screen to the main menu screen 110 by the shortcut, to be respectively valid/invalid. Accordingly, it is possible to respectively set one operation and the other operation to be valid/invalid.

(5) As the athletic performance measuring apparatus, the running measuring apparatus 10 of a form of a wrist watch is considered, but the invention is not limited thereto. For example, various aspects which can be operated in the middle of exercise, such as a cycle computer, a wrist type electronic device, an earphone type electronic device, a ring type electronic device, a pendant type electronic device, an electronic device which is used being mounted in sport equipment, a smartphone, and a head mount display (HMD) can be considered.

(6) The athletic performance measuring apparatus may include at least one arbitrary sensor which can be used in calculating the athletic performance. For example, a pressure sensor, a speed sensor, a geomagnetic sensor, an acceleration sensor, a gyro sensor, a pedometer, a power meter, a temperature sensor, or a humidity sensor, may be included. In addition, the processing portion 20 which calculates the athletic performance and the sensor may be configured from a separated apparatus, and may function as an athletic performance measuring apparatus or an athletic performance measuring system as the sensor and the processing portion communicate with each other.

In addition, each functional portion of the processing portion 20 illustrated in FIG. 2 illustrates functional configurations realized by allowing the hardware and software to collaborate with each other, and the specific embodiment is not particularly limited. Therefore, it is not necessary to mount hardware which respectively corresponds to each functional portion, and it is also needless to say a configuration in which the functions of the plurality of functional portions are realized by performing the program by one processor is employed. In addition, in the above-described embodiment, a part of the function to be realized by the software may be realized by the hardware, or a part of the function to be realized by the hardware may be realized by the software.

What is claimed is:

1. An athletic performance measuring apparatus comprising:
a sensor;
at least one input portion which receives an input; and
a processor,
wherein the processor calculates athletic performance information based on an output from the sensor, performs first processing related to the athletic performance information in a case where at least the one input portion receives a first input, performs the first processing in a case where at least the one input portion receives a second input of which the number of operations is smaller than that of the first input, and invalidates a response to the second input in a case where at least the one input portion receives a first setting.

2. The athletic performance measuring apparatus according to claim 1,
wherein the processor validates the response in a case where at least the one input portion receives a second setting.

3. The athletic performance measuring apparatus according to claim 2, further comprising:
a storage portion which stores a parameter that corresponds to the first setting or the second setting,
wherein the processor stores the parameter in the storage portion in accordance with the first setting or the second setting which is received by at least the one input portion, and
wherein, in a case where at least the one input portion receives the second input, it is determined whether the response is valid or invalid based on the parameter stored in the storage portion.

4. The athletic performance measuring apparatus according to claim 1,
wherein the processor performs a control which corresponds to an instruction related to a supply of a power source in a case where at least the one input portion receives the first setting and in a case where the second input is the instruction related to the supply of the power source.

5. The athletic performance measuring apparatus according to claim 1,
wherein the first processing includes at least one of operating a predetermined function related to the athletic performance and finishing the predetermined function related to the athletic performance.

6. The athletic performance measuring apparatus according to claim 5, further comprising:
a display portion which displays a first screen and a second screen that configure a layered structure,
wherein the operating the predetermined function includes transiting display of the display portion from the first screen to the second screen.

7. The athletic performance measuring apparatus according to claim 5, further comprising:
a display portion which displays a first screen and a second screen that configure a layered structure,
wherein the finishing the predetermined function includes transiting display of the display portion from the second screen to the first screen.

8. The athletic performance measuring apparatus according to claim 1,
wherein the sensor includes at least one of a positional information detection sensor which detects positional information and a bio-information detection sensor which detects bio-information.
